(19) United States
(12) Patent Application Publication
(10) Pub. No.: US 2014/0140714 A1
(43) Pub. Date: May 22, 2014

(54) FIXING DEVICE AND IMAGE FORMING APPARATUS

(71) Applicant: FUJI XEROX CO., LTD., Tokyo (JP)

(72) Inventors: Yasuto OKABAYASHI, Kanagawa (JP); Yasuhiro UEHARA, Kanagawa (JP); Hitoshi OKAZAKI, Kanagawa (JP); Hisashi MURASE, Kanagawa (JP); Toshiyuki MIYATA, Kanagawa (JP)

(73) Assignee: FUJI XEROX CO., LTD., Tokyo (JP)

(21) Appl. No.: 13/860,919

(22) Filed: Apr. 11, 2013

(30) Foreign Application Priority Data
Nov. 20, 2012 (JP) 2012-254144

(51) Int. Cl. G03G 15/20

(52) U.S. Cl. CPC G03G 15/2064
USPC 399/68

(57) ABSTRACT

A fixing device includes an endless belt, a heating unit that heats the belt, a rotating body that rotates while applying pressure to a recording medium interposed between the rotating body and the belt, a pressing member that forms a first area in which the recording medium is to be nipped between the belt and the rotating body by pressing the belt against the rotating body from an inside of the belt, and a driving member that drives the rotating body so that the rotating body rotates at a speed determined such that a time obtained by dividing a length of the first area in a direction in which the rotating body is rotating by the speed is approximately 20 milliseconds or less.

### CROSS-REFERENCE TO RELATED APPLICATIONS

This application is based on and claims priority under 35 USC 119 from Japanese Patent Application No. 2012-254144 filed Nov. 20, 2012.

### BACKGROUND

(i) Technical Field

The present invention relates to a fixing device and an image forming apparatus.

(ii) Related Art

A fixing device is known that fixes toner onto a sheet by applying heat to a sheet to which a toner image has been transferred at a nip that is defined by a heating belt and a pressure roller.

### SUMMARY

According to an aspect of the invention, there is provided a fixing device including an endless belt, a heating unit that heats the belt, a rotating body that rotates while applying pressure to a recording medium interposed between the rotating body and the belt, a pressing member that forms a first area in which the recording medium is to be nipped between the belt and the rotating body by pressing the belt against the rotating body from the inside of the belt, and a driving member that drives the rotating body so that the rotating body rotates at a speed determined such that a time obtained by dividing a length of the first area in a direction in which the rotating body is rotating by the speed is approximately 20 milliseconds or less.

### BRIEF DESCRIPTION OF THE DRAWINGS

Exemplary embodiments of the present invention will be described in detail based on the following figures, wherein:

FIG. 1 is a schematic diagram of an internal configuration of an image forming apparatus;

FIG. 2 is an enlarged view of a portion II illustrating a fixing device;

FIG. 3 is an enlarged view of a portion III illustrating a cross-sectional view of a fixing belt;

FIG. 4 is a table showing examples of a heating time;

FIG. 5 is a graph representing heat loss of the fixing belt;

FIG. 6A is a table showing specifications of the fixing belt and a pressure roller in a simulation conducted to find a relationship between the heating time and heat loss of the fixing belt;

FIG. 6B is a graph showing the relationship between the heating time and heat loss of the fixing belt; and

FIG. 7 is another graph showing the relationship between the heating time and heat loss of the fixing belt.

### DETAILED DESCRIPTION

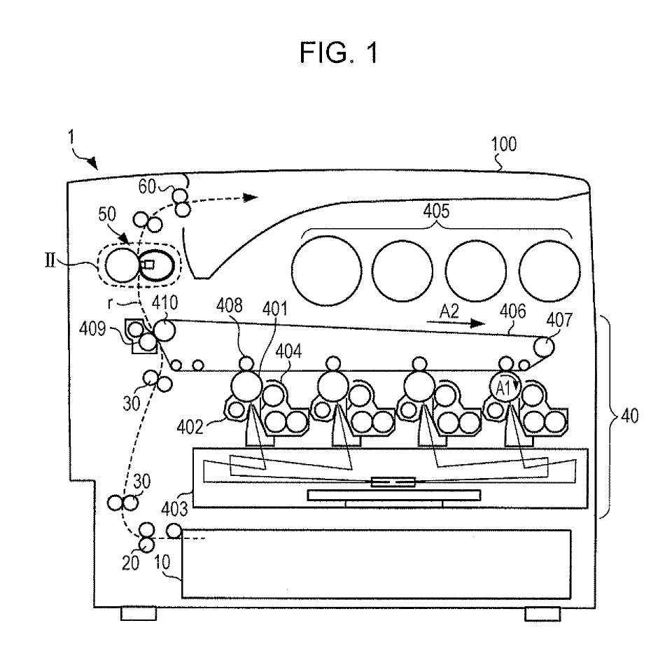

FIG. 1 is a diagram illustrating a schematic internal configuration of an image forming apparatus 1 according to an exemplary embodiment of the invention. The image forming apparatus 1 is an apparatus that functions as a copying machine, a printer, a scanner, a facsimile, or the like. The image forming apparatus 1 includes, in a housing 100, an accommodating unit 10, feed rollers 20, transport rollers 30, a transfer section 40, a fixing device 50, and ejection rollers 60. The accommodating unit 10 accommodates sheets p (examples of recording media). The feed rollers 20 come into contact with one of the sheets p, which are accommodated in the accommodating unit 10, and feed the sheet p along a transport path r (a chain line in FIG. 1). The transport rollers 30 are members having a cylindrical shape. The transport rollers 30 rotate about their own axes and transport the sheet p, which has been fed by the feed rollers 20. The sheet p passes through the transfer section 40 by being transported by the transport rollers 30. The transfer section 40 transfers a toner image to the sheet p, which has been transported by the transport rollers 30. The fixing device 50 fixes toner onto the sheet p by heating the sheet p to which the toner image has been transferred by the transfer section 40. The ejection rollers 60 eject the sheet p on which the toner has been fixed from the image forming apparatus 1.

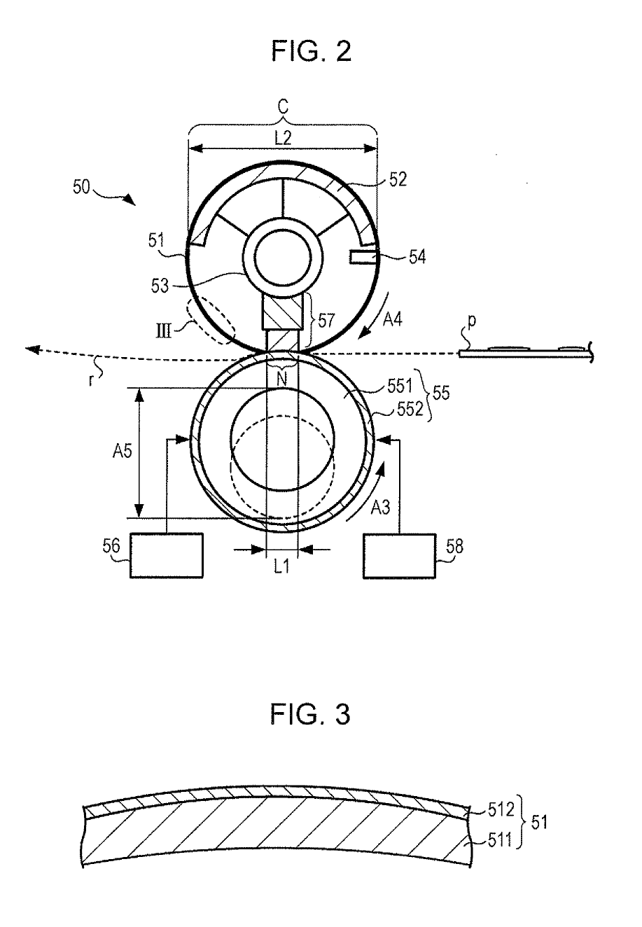

The transfer section 40 includes photoconductor drums 401, chargers 402, an exposure device 403, developing devices 404, toner cartridges 405, an intermediate transfer belt 406, a rotating roller 407, first transfer rollers 408, a second transfer roller 409, and a backup roller 410. The photoconductor drums 401 are members having a cylindrical shape, and a photoconductive film is formed on the outer circumferential surface of each of the photoconductor drums 401. The photoconductor drums 401 are supported so as to rotate about their own axes. The photoconductor drums 401 are arranged so as to be in contact with the intermediate transfer belt 406 and rotate in the direction of arrow A1 of FIG. 1 along with a movement of the intermediate transfer belt 406. The chargers 402 are, for example, scorotron chargers and charge the photoconductive films of the photoconductor drums 401 to a predetermined potential. The exposure device 403 exposes the photoconductor drums 401, which have been charged by the chargers 402, to light and thus forms electrostatic latent images. Each of the developing devices 404 contains a two-component developer containing toner of a corresponding one of yellow (Y), magenta (M), cyan (C), and black (K) and a magnetic carrier such as ferrite powder. The developing devices 404 form toner images by causing the toner to adhere to the electrostatic latent images that have been formed on the photoconductor drums 401. Each of the developing devices 404 is connected to a corresponding one of the toner cartridge 405 via a toner supply path, and is replenished with the toner from the corresponding toner cartridge 405 by rotational operation of a dispensing motor (not illustrated). The intermediate transfer belt 406 is a member that is in the form of an endless belt and rotates in the direction of arrow A2 of FIG. 2. The rotating roller 407 is a member having a cylindrical shape and rotates about its own axis. The rotating roller 407 supports the intermediate transfer belt 406 so as to allow the intermediate transfer belt 406 to move. The first transfer rollers 408 are members having a cylindrical shape and face the corresponding photoconductor drums 401 across the intermediate transfer belt 406. A transfer bias is applied to each of the first transfer rollers 408 from a power supply (not illustrated), and a potential difference is generated between each of the first transfer rollers 408 and the corresponding photoconductor drum 401. Each of the first transfer rollers 408 transfers the toner image, which has been formed on the surface of the corresponding photoconductor drums 401, to a surface of the intermediate transfer belt 406. The second transfer roller 409 is a member having a cylindrical shape and faces the backup roller 410 across the intermediate transfer belt 406. A transfer bias is applied to the second transfer roller 409 from the power supply (not illustrated), and a potential difference is generated between the second transfer roller 409 and the backup roller 410. The second transfer roller 409 transfers the toner images, which have been transferred on the surface of the intermediate transfer belt 406, to the sheet p.

The image forming apparatus 1 also includes a controller, a communicating unit, and a memory, which are not illustrated in the drawings. The controller controls the operation of each unit of the image forming apparatus 1 described above. The controller includes a central processing unit (CPU), a read only memory (ROM), and a random access memory (RAM). The communicating unit is connected to an external apparatus such as a personal computer or a facsimile machine so as to transmit and receive image data to and from the external apparatus. The memory includes a device that stores data and programs used by the controller, such as a hard disk drive (HIM). With the above configuration, the image forming apparatus 1 forms and fixes toner images on the sheet p through a process in which the sheet p is transported along the transport path r. Hereinbelow, a direction in which the sheet p is to be transported is simply referred to as “a transport direction”, and a direction perpendicular to the transport direction is simply referred to as “a width direction”.

FIG. 2 is an enlarged view of a portion II of FIG. 1, the portion II illustrating the fixing device 50 according to the exemplary embodiment of the invention. The fixing device 50 includes a fixing belt 51, a heater 52, a heater support 53, a temperature sensor 54, a pressure roller 55, a contact/separation mechanism 56, a pressure pad 57, and a driving member 58. The fixing belt 51 is an endless belt that fixes toner onto the sheet p by heat.

FIG. 3 is an enlarged view of a portion III of FIG. 2, the portion III illustrating a cross-sectional view of the fixing belt 51 according to the exemplary embodiment of the invention. The fixing belt 51 includes, for example, a base material layer 511 and a release layer 512. The base material layer 511 contains, for example, a metal such as iron as a base material. Instead, the base material layer 511 may contain a material having heat resistance and flexibility, such as a polyimide, as a base material. In this case, a thermally-conductive filler such as aluminum oxide may be dispersed in the base material layer 511. Since the release layer 512 comes into contact with toner images that have been transferred to the sheet p, the release layer 512 is made of a material that allows toner to easily be released therefrom. For example, a layer that is made of tetrafluoroethylene-perfluoroalkyl vinyl ether polymer (PFA), polytetrafluoroethylene (PTFE), a silicone copolymer, or a composite of these materials is used as the release layer 512. An elastic layer that is made of an elastic body such as silicone rubber may be interposed between the base material layer 511 and the release layer 512.

Returning to FIG. 2, the heater 52 (an example of a heating unit) is a sheet-like member that heats the fixing belt 51 from the inside of the fixing belt 51. The heater 52 has flexibility and is disposed over the inner circumferential surface of the fixing belt 51. The heater 52 includes a resistance heating element made of, for example, aluminum. When electric power is supplied to the heater 52 from the power supply (not illustrated), the heater 52 generates heat. The heat generated by the heater 52 is transferred to the fixing belt 51. The heater support 53 is a member that supports the heater 52. The heater support 53 supports the heater 52 such that the heater 52 is in contact with the inner circumferential surface of the fixing belt 51. Thus, the heater 52 has a contact area C (an example of a second area) over which the heater 52 is in contact with the fixing belt 51. The temperature sensor 54 is a sensor such as a thermistor that is mounted on the fixing belt 51 in order to measure the temperature of the fixing belt 51.

The pressure roller 55 (an example of a rotating body) is a member that comes into contact with the sheet p and applies pressure to the sheet p. The pressure roller 55 is a member having a cylindrical shape and rotates in the transport direction (the direction of arrow A3 of FIG. 2) while applying pressure to the sheet p interposed between the pressure roller 55 and the fixing belt 51. When the pressure roller 55 rotates, the fixing belt 51 is driven by the pressure roller 55 and rotates in the direction of arrow A4 of FIG. 2. The pressure roller 55 includes an elastic body layer 551 and a release layer 552. The elastic body layer 551 is made of a material having heat resistance and elasticity such as foamed silicone rubber. The elastic body layer 551 may be made of non-foamed solid silicone rubber. The release layer 552 is a layer that comes into contact with the sheet p, and is made of a material that allows the sheet p to easily separate therefrom. The release layer 552 is made of, for example, a material that has heat resistance and that allows the sheet p to easily separate from the release layer 552, such as PFA or PTFE. The release layer 552 may contain carbon. The contact/separation mechanism 56 moves the pressure roller 55 in the direction of arrow AS of FIG. 2 and causes the fixing belt 51 and the pressure roller 55 to come into contact with or to become separated from each other. When the pressure roller 55 is in contact with the fixing belt 51, a nip area N (an example of a first area) in which the sheet p is to be nipped is formed, and the pressure roller 55 applies pressure to the sheet p and the fixing belt 51. The nip area N is formed in an area different from the contact area C.

The pressure pad 57 (an example of a pressing member) forms the nip area N between the fixing belt 51 and the pressure roller 55. The pressure pad 57 forms the nip area N by pressing the fixing belt 51 against the pressure roller 55 from the inside of the fixing belt 51. The pressure pad 57 is made of, for example, an elastic body such as silicone rubber or fluoro rubber. The pressure pad 57 may be made of a heat-resistant resin such as a liquid crystal polymer. An end of the pressure pad 57 on the opposite side to the nip area N is fixed to the heater support 53. The driving member 58 is a member that drives the pressure roller 55 so that the pressure roller 55 rotates. A speed v at which the driving member 58 causes the pressure roller 55 to rotate is determined in accordance with the relationship between the speed v and the length L1 of the nip area N in the transport direction. More specifically, the speed v is determined such that the time obtained by dividing the length L1 by the speed v is within a predetermined range. The time corresponds to the time for which a point on the sheet p is heated by the fixing belt 51 in the nip area N. The time is hereinbelow referred to as “a heating time D”, and D=L1/V. The length L1 is shorter than the length L2 of the contact area C in the transport direction, that is, the length L2 is longer than the length L1.

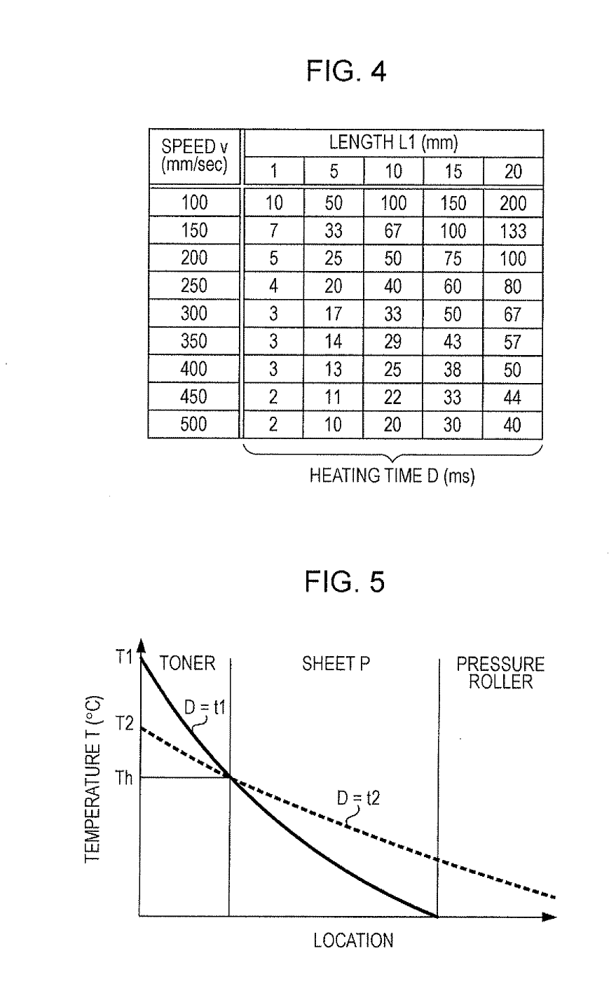

FIG. 4 is a table showing examples of the heating time D (ms). FIG. 4 shows the heating time D when the length L1 of the nip area N in the transport direction and the speed v at which the pressure roller 55 rotates are given as shown in the table. In the cases illustrated in FIG. 4, the length L1 is set to 1, 5, 10, 15, and 20 mm, and the speed v is set within a range of 100 mm/sec to 500 mm/sec at 50 mm/sec intervals. For example, when L1=1 mm and v=100 mm/sec, D is 10 ms. Instead, when L1=20 mm and v=500 mm/sec, D is 40 ms. The heating time D decreases as the length L1 decreases. The heating time D also decreases as the speed v increases.

FIG. 5 is a graph representing heat loss of the fixing belt 51. In FIG. 5, the horizontal axis represents a location in a direction from the sheet p toward the center of the pressure roller 55. In FIG. 5, the left end of the horizontal axis represents a surface of a toner image. The vertical axis represents temperature. A solid line of FIG. 5 represents the characteristic when the fixing belt 51 is heated at a relatively high temperature T1 for a short time t1, and a dashed line represents the characteristic when the fixing belt 51 is heated at a low temperature T2 for a long time t1 (i.e., T1>T2 and t1<t2). A threshold Th represents the temperature at which toner melts. In order to fix the toner onto the sheet p, it is necessary that the temperature over the entire area of a layer of the toner (hereinbelow referred to as a toner layer) be not lower than the threshold Th. In the case illustrated in FIG. 5, the temperatures T1 and T2 and the times t1 and t2 are set such that the temperature at an interface between the toner and the sheet p is the threshold Th. The amount of heat transferred from the fixing belt 51 to the toner, the sheet p, and the pressure roller 55, which is equivalent to a power consumption of the heater 52, corresponds to the value obtained by integrating each of the characteristics illustrated in FIG. 5 from a surface of a toner image to the center of the pressure roller 55. In the case illustrated in FIG. 5, the power consumption of the heater 52 in the case where the fixing belt 51 is heated at the relatively high temperature T1 for the short time t1 is smaller than that in the case where the fixing belt 51 is heated at the low temperature T2 for the long time t1. A range of the heating time D that is appropriate for reducing heat loss will be described below on the basis of results of a computer simulation.

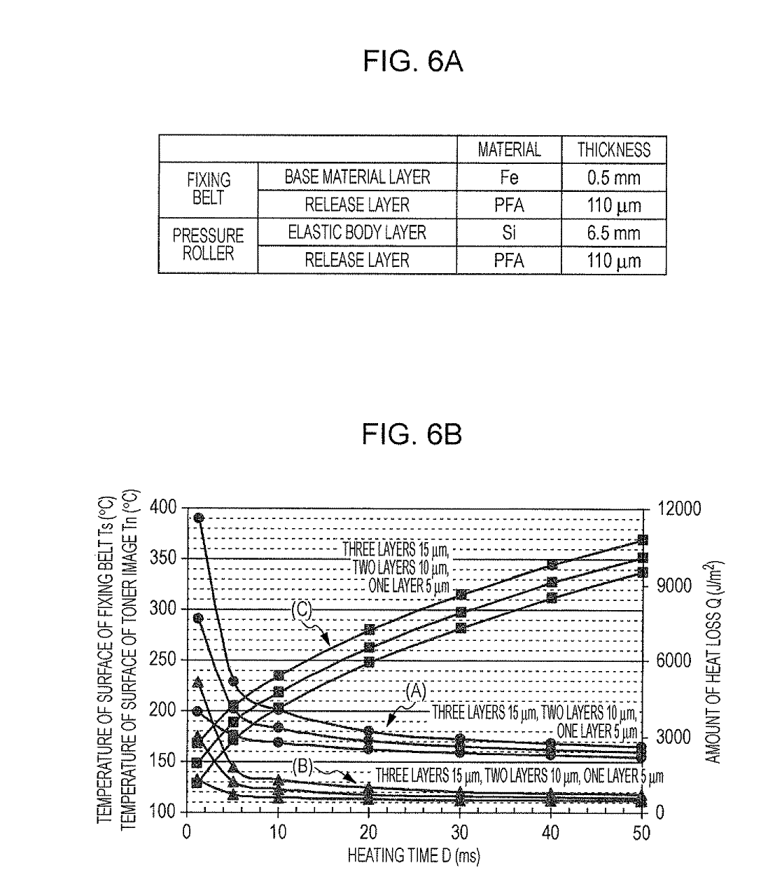

FIGS. 6A and 6B are diagrams that relate to a simulation conducted to find a relationship between the heating time D and heat loss of the fixing belt 51. FIG. 6A shows specifications of the fixing belt 51 and the pressure roller 55 in the simulation. In the simulation, the base material layer 511 of the fixing belt 51 is made of iron and has a thickness of 0.5 mm, and the release layer 512 of the fixing belt 51 is made of PFA and has a thickness of 110 μm. The elastic body layer 551 of the pressure roller 55 is made of silicone and has a thickness of 6.5 mm, and the release layer 552 of the pressure roller 55 is made of PFA and has a thickness of 110 μm. The thickness of the sheet p is 98 μm, and the basis weight of the sheet p is 82 g/m² in the simulation.

FIG. 6B shows a relationship between a temperature of a surface of the fixing belt 51 (A) and the heating time D, a relationship between a temperature of a surface of a toner image (B) and the heating time D, and a relationship between heat loss (C) and the heating time D. The horizontal axis represents the heating time D (ms). The vertical axis on the left represents the temperature Ts (° C.) of the surface of the fixing belt 51 heated by the heater 52 or the temperature Tn (° C.) of the surface of the toner image heated by the fixing belt 51, and the vertical axis on the right represents the amount of heat loss Q (J/m²) per unit area of the fixing belt 51. FIG. 6B shows results of a simulation when the diameter of toner particles is 5.8 μm, and when the toner layer that is transferred to the sheet p has a thickness of 5 μm, 10 μm, or 15 μm. The thickness of the toner layer varies depending on, for example, the diameter of the toner particles and whether the printing to be performed is color printing or monochrome printing. For example, the toner layer having a thickness of 5 μm corresponds to a single layer (i.e., monochrome printing), and the toner layer having a thickness of 10 μm or 15 μm corresponds to two layers or three layers (i.e., color printing).

From the standpoint of reliability of the fixing belt 51, it is preferable that the temperature Ts of the surface of the fixing belt 51 be low. On the other hand, from the standpoint of power consumption, it is preferable that the amount of heat loss Q of the fixing belt 51 be low. When the heating time D increases, the temperature Ts decreases, but the amount of heat loss Q increases. Thus, it cannot be simply said that it is preferable that the heating time D be short or it is preferable that the heating time D be long. In FIG. 6B, in a range in which the heating time D is less than 5 ms, slopes of Ts-D curves is sharper, that is, the absolute values of the slopes of the Ts-D curves exceed the threshold Th. Thus, it is preferable that the heating time D be not less than 5 ms or not less than approximately 5 ms.

In FIG. 6B, when the heating time D is more than 20 ms, the absolute values of the slopes of the Ts-D curves become smaller than those in the case where the heating time D is 20 ms or less, and even when the heating time D increases, the heating time D affects the reliability of the fixing belt 51 to a lesser degree. On the other hand, the amount of heat loss Q keeps increasing substantially linearly when the heating time D is more than 20 ms. Therefore, it is preferable that the heating time D be not more than 20 ms or not more than approximately 20 ms. Since it is preferable that the heating time D be short from the standpoint of heat loss, it is preferable that the heating time D be, for example, 10 ms or approximately 10 ms.

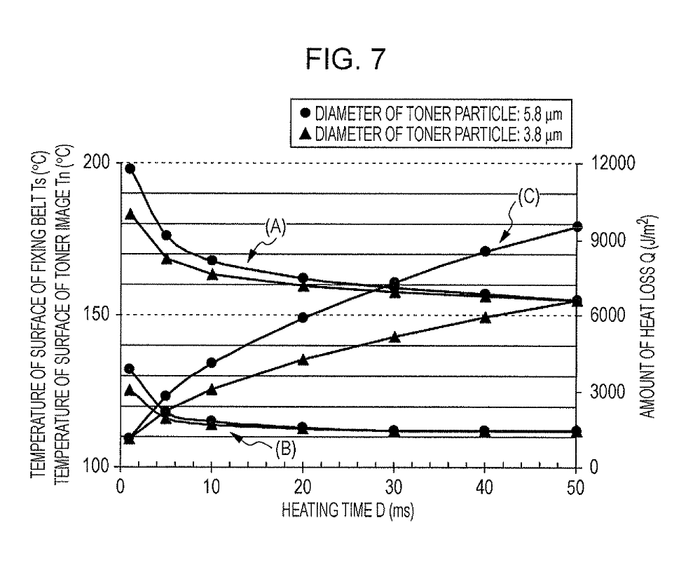

FIG. 7 is another graph showing results of another simulation that shows a relationship between the heating time D and heat loss of the fixing belt 51. FIG. 7 shows results of a simulation performed with specifications the same as those shown in FIG. 6A when the diameter of the toner particles is 5.8 μm and 3.8 μm. In FIG. 7, the toner layer is a single layer. In FIG. 7, in the case where the diameter of the toner particles is 3.8 μm, the slopes of the Ts-D curves is sharper in a range in which the heating time D is shorter than 5 ms, and thus, it is preferable that the heating time D be not less than 5 ms or not less than approximately 5 ms regardless of the diameter of the toner particles. In FIG. 7, in the case where the diameter of the toner particles is 3.8 μm, when the heating time D is more than 20 ms, the absolute values of the slopes of the Ts-D curves become smaller than those when the heating time D is 20 ms or less. In addition, when the heating time D is more than 20 ms, the amount of heat loss Q keeps increasing substantially linearly. Therefore, it is preferable that the heating time D be not more than 20 ms or not more than approximately 20 ms regardless of the diameter of the toner particles. The temperature Ts of the surface of the fixing belt 51 and the amount of heat loss Q of the fixing belt 51 in the case where the diameter of the toner particles is 3.8 μm are lower than those in the case where the diameter of the toner particles is 5.8 μm. Consequently, the toner particles having a diameter of 3.8 μm are more suitable than the toner particles having a diameter of 5.8 μm from the standpoints of reliability of the fixing belt 51 and heat loss.

Returning to FIG. 4, in the cases illustrated in FIG. 4, when L1=1 mm and v=100, 150, or 200 mm/sec, the heating time D is 5 ms≦D≦20 ms. In addition, when L1=5 mm and v=250, 300, 350, 400, 450, or 500 mm/sec, the heating time D is 5 ms≦D≦20 ms. Furthermore, when L1=10 mm and v=500 mm/sec, the heating time D is 5 ms≦D≦20 ms. Modification

The present invention is not limited to the above-described exemplary embodiment, and various modifications may be made. Some modifications will now be described below. Two or more modifications among the following modifications may be employed in combination.

### (1) Modification 1

Specific values shown in FIG. 4 that represent the length L1 and the speed v are merely examples, and the length L1 and the speed v to which the present invention is applied are not limited to these values. The length L1 and the speed v may be any values as long as the heating time D is within the above-mentioned range.

### (2) Modification 2

A material of the resistance heating element in the heater 52 is not limited to aluminum. A resistance heating element may be made of copper, nickel, chrome, or the like. In the heater 52, the resistance heating element may be covered with a material having heat resistance and flexibility such as silicone or polyimide.

### (3) Modification 3

The heating unit is not limited to the heater 52 and may be any device that heats the fixing belt 51. For example, a halogen lamp may be used as the heating unit. Instead, a heat storage plate that is to be heated by electromagnetic induction may be used as the heating unit. In this case, a coil that generates an alternating magnetic field for causing the heat storage plate to generate heat is provided in the fixing device 50. As in the case of the heater 52, the heat storage plate is disposed over the inner circumferential surface of the fixing belt 51. Alternatively, a conductive heat generating layer that is to be heated by electromagnetic induction may be included in the fixing belt 51 as the heating unit.

### (4) Modification 4

The case in which the speed v at which the driving member 58 causes the pressure roller 55 to rotate is determined in accordance with the length L1 of the nip area N in the transport direction is described in the above-described exemplary embodiment. Regarding this, the length L1 of the nip area N in the transport direction may be determined in accordance with the speed v at which the pressure roller 55 rotates. In other words, the length L1 and the speed v may be any values as long as the heating time D is within the above-mentioned range.

### (5) Modification 5

The case in which the contact/separation mechanism 56 moves the pressure roller 55 is described in the above-described exemplary embodiment. Regarding this, the contact/separation mechanism 56 may move the fixing belt 51 and cause the fixing belt 51 and the pressure roller 55 to come into contact with or to become separated from each other.

### (6) Other Modifications

Although the case in which the sheet p is a cut sheet having predetermined dimensions is described in the above-described exemplary embodiment, the sheet p may be a continuous roll of paper (also called as a continuous business form or a continuous form) that has not been cut into a sheet.

The structures of the fixing belt 51 and the pressure roller 55 are not limited to those described in the exemplary embodiment.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising;
an endless belt;
a heating unit that heats the belt;
a rotating body that rotates while applying pressure to a recording medium interposed between the rotating body and the belt;
a pressing member that forms a first area in which the recording medium is to be nipped between the belt and the rotating body by pressing the belt against the rotating body from an inside of the belt; and
a driving member that drives the rotating body so that the rotating body rotates at a speed determined such that a time obtained by dividing a length of the first area in a direction in which the rotating body is rotating by the speed is approximately 20 milliseconds or less.

2. The fixing device according to claim 1,
wherein the time is approximately 5 milliseconds or more.

3. The fixing device according to claim 1,
wherein the time is approximately 10 milliseconds or less.

4. The fixing device according to claim 1,
wherein the heating unit includes a second area over which the heating unit is in contact with the belt in an area different from the first area, and
wherein a length of the second area in the direction in which the rotating body is rotating is longer than the length of the first area in the same direction.

5. The fixing device according to claim 2,
wherein the heating unit includes a second area over which the heating unit is in contact with the belt in an area different from the first area, and
wherein a length of the second area in the direction in which the rotating body is rotating is longer than the length of the first area in the same direction.

6. The fixing device according to claim 3,
wherein the heating unit includes a second area over which the heating unit is in contact with the belt in an area different from the first area, and
wherein a length of the second area in the direction in which the rotating body is rotating is longer than the length of the first area in the same direction.

7. The fixing device according to claim 1, further comprising:
a contact/separation mechanism that causes the belt and the rotating body to come into contact with or to become separated from each other.

8. The fixing device according to claim 2, further comprising:
a contact/separation mechanism that causes the belt and the rotating body to come into contact with or to become separated from each other.

9. The fixing device according to claim 3, further comprising:
a contact/separation mechanism that causes the belt and the rotating body to come into contact with or to become separated from each other.

10. The fixing device according to claim 4, further comprising:
a contact/separation mechanism that causes the belt and the rotating body to come into contact with or to become separated from each other.

11. The fixing device according to claim 5, further comprising:
a contact/separation mechanism that causes the belt and the rotating body to come into contact with or to become separated from each other.

12. The fixing device according to claim 6, further comprising:
a contact/separation mechanism that causes the belt and the rotating body to come into contact with or to become separated from each other.

13. An image forming apparatus comprising:
a transfer section that transfers a toner image to a recording medium;
an endless belt;
a heating unit that heats the belt;
a rotating body that rotates while applying pressure to the recording medium interposed between the rotating body and the belt;
a pressing member that forms a first area in which the recording medium is to be nipped between the belt and the rotating body by pressing the belt against the rotating body from an inside of the belt; and
a driving member that drives the rotating body so that the rotating body rotates at a speed determined such that a time obtained by dividing a length of the first area in a direction in which the rotating body is rotating by the speed is approximately 20 milliseconds or less.
